(19) United States
(12) Patent Application Publication
(10) Pub. No.: US 2016/0288469 A1
(43) Pub. Date: Oct. 6, 2016

(54) LAYERED MATERIAL AND DEVICE AND METHOD FOR PRODUCING A LAYERED MATERIAL

(71) Applicant: MAYR-MELNHOF KARTON AG, Wien (AT)

(72) Inventors: Gernot Schleiss, Graz (AT); Mathias Magin, Schifferstadt (DE)

(21) Appl. No.: 15/037,416

(22) PCT Filed: Nov. 20, 2014
(86) PCT No.: PCT/EP2014/075202

§ 371 Date: May 18, 2016

(30) Foreign Application Priority Data
Nov. 22, 2013 (DE) 20 2013 105 317.1

(51) Int. Cl. B32B 29/02; B32B 37/00; B32B 27/10; B32B 37/12; B32B 5/02; B32B 7/12

(52) U.S. Cl. CPC B32B 29/02; B32B 5/028; B32B 7/12; B32B 27/10; B32B 37/12; B32B 37/0053; B32B 2439/62

(57) ABSTRACT

The present invention relates to a layered material for use as packaging material, comprising at least two layers of cardboard and/or paper, which are connected to one another in a material-bonded manner, wherein at least one intermediate layer of a gauze-like or fabric-like reinforcing material is arranged between the layers of cardboard and/or paper. and at least one cardboard layer or paper layer has a proportion of recycled fibres of at least 80% by weight with respect to the total weight of the cardboard layer or paper layer. The invention also relates to a three-dimensional structure produced from the layered material and to a device and a method for producing a layered material for use as packaging material comprising at least two layers of cardboard and/or paper that are connected to one another in a material-bonded manner.

The invention relates to a layered material for use as a packaging material comprising at least two layers of cardboard and/or paper, which are connected to each other in material-bonded manner. Furthermore, the invention relates to a three-dimensional structure produced from a layered material as well as to a device and a method for producing a layered material for use as a packaging material including at least two layers of cardboard and/or paper, which are connected to each other in material-bonded manner.

Layered materials for use as a packaging material are known in a great plurality. Thus, DE 35 13 579 A1 for example describes a corrugated paperboard with a cover web and a corrugated web adhered thereto. In order to impart a substantially increased strength to this corrugated paperboard for occurring loading cases, it is provided to insert a reinforcing network between two corrugated layers of the corrugated web adhered to each other. Therein, the reinforcing network is in particular composed of plastic threads or fibers or natural fibers. Glass fibers can also be used. However, it is disadvantageous in this known corrugated paperboard that both corrugated layers are composed of so-called kraft liners. Therein, kraft liners are paper or cardboard raw materials, which are composed of fresh fibers in at least 80%. By the use of a kraft liner, particularly strong and stable paper or cardboard layers arise. The same applies to known beverage holders, which are also mostly produced from kraft cellulose in order to thus be able to achieve the required strength characteristics. However, in the use of kraft liners and kraft celluloses, respectively, the high raw material cost on the one hand and the consumption of natural resources on the other hand are disadvantageous.

It is the object of the invention to provide a layered material for use as a packaging material and a three-dimensional structure produced from the layered material, which have increased mechanical strengths on the one hand and can be produced in environmentally friendly and inexpensive manner on the other hand. Furthermore, it is the object of the present invention to provide a corresponding device and a method for producing a layered material for use as a packaging material.

These objects are solved by a layered material having the features of claim 1, a three-dimensional structure having the features of claim 12, a device having the features of claim 14 as well as a method having the features of claim 16. Advantageous configurations with convenient developments of the invention are specified in the respective dependent protective claims.

A first aspect of the invention relates to a layered material for use as a packaging material including at least two layers of cardboard and/or paper, which are connected to each other in material-bonded manner. Therein, at least one intermediate layer of a net- or fabric-like reinforcing material is arranged between the layers of cardboard and/or paper and at least one cardboard layer or paper layer has a proportion of recycled fibers of at least 80% by weight related to the total weight of the cardboard layer or paper layer. By the use of a very high proportion of recycled fibers, for example obtained by recycling waste paper, the layered material according to the invention can be produced in environmentally friendly and inexpensive manner. By the further use of a net- or fabric-like reinforcing material, which is inserted between the layers of cardboard and/or paper, a very high mechanical strength of the layered material is additionally ensured. A packaging material produced from the layered material according to the invention can be used in particular for producing product carriers such as for example carriers for bottles or cans due to the excellent mechanical characteristics. The proportion of used fresh fiber can be reduced to less than 1% by weight related to the total weight of the respective cardboard or paper layer in the production of the layered material according to the invention.

In an advantageous configuration of the layered material according to the invention, the layers of cardboard and/or paper and the intermediate layer of the net- or fabric-like reinforcing material are adhered to each other. Thereby, a material-bonded connection between the mentioned components of the layered material arises, which in turn contributes to the mechanical strength of the layered material. For adhering the layered material, for example, dispersion adhesives based on water as well as starch solutions can be used. The adhesive and/or starch solution is in particular applied in dry coat, wherein the applied quantity is 1-40 g/m², in particular 10-20 g/m². This means that the applied quantity can be 1 g/m², 2 g/m², 3 g/m², 4 g/m², 5 g/m², 6 g/m², 7 g/m², 8 g/m², 9 g/m², 10 g/m², 11 g/m², 12 g/m², 13 g/m², 14 g/m², 15 g/m², 16 g/m², 17 g/m², 18 g/m², 19 g/m², 20 g/m², 21 g/m², 22 g/m², 23 g/m², 24 g/m², 25 g/m², 26 g/m², 27 g/m², 28 g/m², 29 g/m², 30 g/m², 31 g/m², 32 g/m², 33 g/m², 34 g/m², 35 g/m², 36 g/m², 37 g/m², 38 g/m², 39 g/m², 40 g/m². Intermediate values are also possible.

In further advantageous configurations of the layered material according to the invention, the layers of cardboard and/or paper include a first layer of cardboard or paper as a cover layer facing away from a packaging item and a second layer of cardboard and/or paper as a back layer facing the packaging item. Therein, the first and/or second layers can be formed in hydrophobic or moisture repellent manner. Furthermore, there is the possibility that the back layer has an area-related mass of 40-600 g/m² and/or a thickness of 80-1000 μm, in particular 80-800 μm. The same applies to the cover layer. Advantageously, the back and cover layer can be formed according to requirements to the specific packaging. In particular, different coatings, for example moisture repellent and/or antimicrobial coatings, can be used. Furthermore, there is the possibility that the back layer is produced from GD cardboard, a GD liner, grey board, a test liner and/or a paper layer. Furthermore, the back layer can be produced in coated and/or uncoated manner. The cover layer is produced from a GD cardboard or a GD liner or a coated paper layer. It is common to the back layer and the cover layer that at least one of these layers has a proportion of recycled fibers of at least 80% by weight related to the total weight of the respective cardboard layer or paper layer. However, both layers, namely the first and the second layer, can also have a corresponding proportion of recycled fibers.

In further advantageous configurations of the layered material according to the invention, the net- or fabric-like reinforcing material is composed of synthetic and/or natural fiber and/or fabric materials. Therein, the net- or fabric-like reinforcing material can have an area-related mass of 1-30 g/m², in particular 1-15 g/m². The selection of the reinforcing material again is dependent on the use of the layered material or on the type of the packaging to be produced from the layered material. Advantageously, a plurality of possibilities arises, which can be adapted to the corresponding requirements to the packaging material and the layered material, respectively.

A second aspect of the invention relates to a three-dimensional structure produced from a layered material as described above in the first inventive aspect. Such a three-dimensional structure according to the invention can for example be a folding box, a product carrier, a display, in particular for presentation of goods, or the like. Advantageously, such a three-dimensional structure can be inexpensively produced and saves the natural resources by the very high proportion of recycled fibers in the layered material. By the use of the net- or fabric-like reinforcing material, three-dimensional structures can be produced, the mechanical characteristics of which can be compared to corresponding three-dimensional structures produced from mostly fresh fibers or even are superior to these mechanical characteristics.

The features and advantages resulting from the use of the layered material according to this first inventive aspect are apparent from the descriptions of the first inventive aspect, wherein advantageous configurations of the first inventive aspect are to be regarded as advantageous configurations of the second inventive aspect and vice versa.

A third aspect of the invention relates to a device for producing a layered material for use as a packaging material including at least two layers of cardboard and/or paper, which are connected to each other in material-bonded manner, wherein the device includes at least a first transport device for transporting a first cardboard or paper web forming a first cardboard or paper layer, a second transport device for transporting a second cardboard or paper web forming a second cardboard or paper layer, a third transport device for transporting a web of a net- or fabric-like reinforcing material, at least one device for applying an adhesive and/or starch solution to the first and/or the second cardboard or paper web as well as a device for combining the first cardboard or paper web with the second cardboard or paper web as well as the web of the net- or fabric-like reinforcing material for forming the layered material, wherein the web of the net- or fabric-like reinforcing material is guided between the first cardboard or paper web and the second cardboard or paper web. Therein, the first and/or the second cardboard or paper layer have a proportion of recycled fibers of at least 80% by weight related to the total weight of the cardboard layer or paper layer. By means of the device according to the invention, an inexpensive production of the mentioned layered material is possible. In addition, the layered material can be produced in resource saving manner. The adhesive and/or starch solution is in particular applied in dry coat, wherein the applied quantity is 1-40 g/m², in particular 10-20 g/m². This means that the applied quantity can be 1 g/m², 2 g/m², 3 g/m², 4 g/m², 5 g/m², 6 g/m², 7 g/m², 8 g/m², 9 g/m², 10 g/m², 11 g/m², 12 g/m², 13 g/m², 14 g/m², 15 g/m², 16 g/m², 17 g/m², 18 g/m², 19 g/m², 20 g/m², 21 g/m², 22 g/m², 23 g/m², 24 g/m², 25 g/m², 26 g/m², 27 g/m², 28 g/m², 29 g/m², 30 g/m², 31 g/m², 32 g/m², 33 g/m², 34 g/m², 35 g/m², 36 g/m², 37 g/m², 38 g/m², 39 g/m², 40 g/m². Intermediate values are also possible. The layers of cardboard or paper can have a moisture content of less than or equal to 40% by weight during the combination of the first cardboard or paper web with the second cardboard or paper web as well as the web of the net- or fabric-like reinforcing material for forming the layered material. In particular, moisture contents of 5% by weight, 6% by weight, 7% by weight, 8% by weight, 9% by weight, 10% by weight, 11% by weight, 12% by weight, 13% by weight, 14% by weight, 15% by weight, 16% by weight, 17% by weight, 18% by weight, 19% by weight, 20% by weight, 21% by weight, 22% by weight, 23% by weight, 24% by weight, 25% by weight, 26% by weight, 27% by weight, 28% by weight, 29% by weight, 30% by weight, 31% by weight, 32% by weight, 33% by weight, 34% by weight, 35% by weight, 36% by weight, 37% by weight, 38% by weight, 39% by weight, 40% by weight are possible. Intermediate values are also possible.

In further advantageous configurations of the device according to the invention, the device further includes at least one calender and/or at least one removal device and/or at least one application device for additives and/or at least one cutting device and/or at least one drying device for drying the multilayer layered material. Advantageously, the device according to the invention can be formed and varied corresponding to the requirements to the layered material.

The features and advantages resulting from the use of the layered material according to the first inventive aspect are apparent from the descriptions of the first inventive aspect, wherein advantageous configurations of the first inventive aspect are to be regarded as advantageous configurations of the third as well as the second inventive aspect and vice versa.

A fourth aspect of the invention relates to a method for producing a layered material according to the first aspect of the invention. Therein, the method includes at least the steps of applying an adhesive and/or starch solution to a first and/or a second cardboard or paper web and combining the first cardboard or paper web with the second cardboard or paper web as well as a web of a net- or fabric-like reinforcing material for forming the layered material, wherein the web of the net- or fabric-like reinforcing material is guided between the first cardboard or paper web and the second cardboard or paper web. Therein, the first and/or second layers of cardboard or paper can have a moisture content of less than or equal to 40% by weight during the combination of the first cardboard or paper web with the second cardboard or paper web as well as the web of the net- or fabric-like reinforcing material for forming the layered material. In addition, there is the possibility that the adhesive and/or starch solution is applied in dry coat, wherein the applied quantity is 1-40 g/m², in particular 10-20 g/m². The method according to the invention allows efficient production of a layered material, which has increased mechanical strengths on the one hand and can be produced in environmentally friendly and inexpensive manner on the other hand.

The features and advantages resulting from the use of the layered material according to the first inventive aspect are apparent from the descriptions of the first inventive aspect, wherein advantageous configurations of the first inventive aspect are to be regarded as advantageous configurations of the fourth as well as the second and third inventive aspect and vice versa.

The features and feature combinations mentioned above in the description as well as the features and feature combinations mentioned below in the description of figures and/or shown in the figures alone are usable not only in the respectively specified combination, but also in other combinations or alone without departing from the scope of the invention.

Further advantages, features and details of the invention are apparent from the claims, the following description of preferred embodiments as well as based on the drawings.

There show:

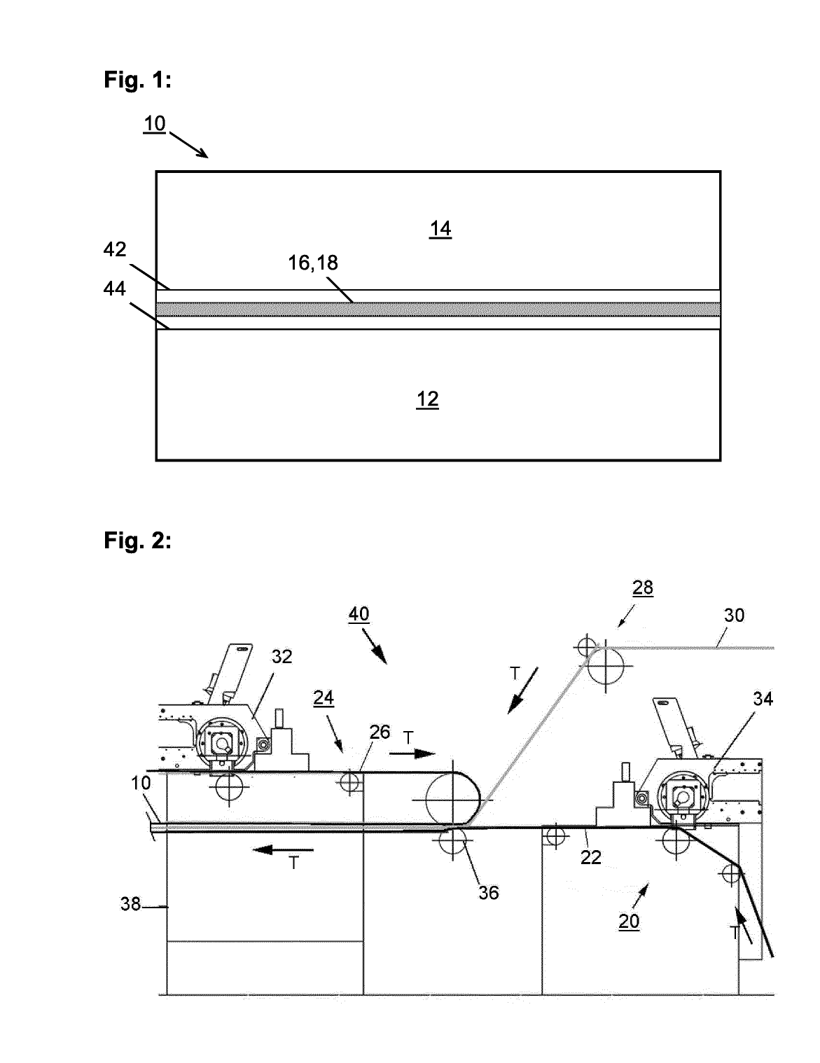

FIG. 1 a schematic sectional representation of the layered material according to the invention; and

FIG. 2 a schematic representation of the device according to the invention for producing a layered material.

FIG. 1 shows a schematic sectional representation of a layered material 10 for use as a packaging material. One recognizes that the represented layered material 10 has two layers 12, 14 of cardboard and/or paper, which are connected to each other in material-bonded manner via the adhesive layers 42, 44. An intermediate layer 16 of a net- or fabric-like reinforcing material 18 is arranged between the layers 12, 14 of cardboard and/or paper. The intermediate layer 16 is also adhered to the layers 12, 14 via the adhesive layers 42, 44. At least one cardboard layer or paper layer 12, 14 has a proportion of recycled fibers of at least 80% by weight related to the total weight of the cardboard layer or paper layer. This proportion can be increased up to above 99% by weight related to the total weight of the cardboard layer or paper layer. This means that the proportion of recycled fibers related to the total weight of the cardboard or paper layer can be 80% by weight, 80.5 by weight, 81 by weight, 81.5 by weight, 82 by weight, 82.5 by weight, 83 by weight, 83.5 by weight, 84 by weight, 84.5 by weight, 85 by weight, 85.5 by weight, 86 by weight, 86.5 by weight, 87 by weight, 87.5 by weight, 88 by weight, 88.5 by weight, 89 by weight, 89.5 by weight, 90 by weight, 90.5 by weight, 91 by weight, 91.5 by weight, 92 by weight, 92.5 by weight, 93 by weight, 93.5 by weight, 94 by weight, 94.5 by weight, 95 by weight, 95.5 by weight, 96 by weight, 96.5 by weight, 97 by weight, 97.5 by weight, 98 by weight, 98.5 by weight, 99 by weight or 99.5 by weight. Intermediate quantities are also possible.

In the illustrated embodiment, the layers 12, 14 include a first layer 12 of cardboard or paper, which forms a cover layer facing away from a packaging item (not illustrated). Therein, a second layer 14 of cardboard or paper forms a back layer facing the packaging item. Therein, at least the first or the second layer 12, 14 has the already described proportion of recycled fibers of at least 80% by weight related to the total weight of the respective cardboard layer or paper layer. At least one of the layers 12, 14 can additionally be formed in hydrophobic and/or moisture repellent manner. Therein, the first and the second layer 12, 14 each have an area-related mass of 40-600 g/m². This means that the area-related mass can be 40 g/m², 45 g/m², 50 g/m², 55 g/m², 60 g/m², 65 g/m², 70 g/m², 75 g/m², 80 g/m², 85 g/m², 90 g/m², 95 g/m², 100 g/m², 105 g/m², 110 g/m², 115 g/m², 120 g/m², 125 g/m², 130 g/m², 135 g/m², 140 g/m², 145 g/m², 150 g/m², 155 g/m², 160 g/m², 165 g/m², 170 g/m², 175 g/m², 180 g/m², 185 g/m², 190 g/m², 195 g/m², 200 g/m², 205 g/m², 210 g/m², 215 g/m², 220 g/m², 225 g/m², 230 g/m², 235 g/m², 240 g/m², 245 g/m², 250 g/m², 255 g/m², 260 g/m², 265 g/m², 270 g/m², 275 g/m², 280 g/m², 285 g/m², 290 g/m², 295 g/m², 300 g/m², 305 g/m², 310 g/m², 315 g/m², 320 g/m², 325 g/m², 330 g/m², 335 g/m², 340 g/m², 345 g/m², 350 g/m², 355 g/m², 360 g/m², 365 g/m², 370 g/m², 375 g/m², 380 g/m², 385 g/m², 390 g/m², 395 g/m², 400 g/m², 405 g/m², 410 g/m², 415 g/m², 420 g/m², 425 g/m², 430 g/m², 435 g/m², 440 g/m², 445 g/m², 450 g/m², 455 g/m², 460 g/m², 465 g/m², 470 g/m², 475 g/m², 480 g/m², 485 g/m², 490 g/m², 495 g/m², 500 g/m², 505 g/m², 510 g/m², 515 g/m², 520 g/m², 525 g/m², 530 g/m², 535 g/m², 540 g/m², 545 g/m², 550 g/m², 555 g/m², 560 g/m², 565 g/m², 570 g/m², 575 g/m², 580 g/m², 585 g/m², 590 g/m², 595 g/m², 600 g/m². Intermediate quantities are also possible. The thickness of the first and the second layer 12, 14 can be between 80 and 800 μm. This means that the thickness of the respective layer can be 80 μm, 90 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, 370 μm, 380 μm, 390 μm, 400 μm, 410 μm, 420 μm, 430 μm, 440 μm, 450 μm, 460 μm, 470 μm, 480 μm, 490 μm, 500 μm, 510 μm, 520 μm, 530 μm, 540 μm, 550 μm, 560 μm, 570 μm, 580 μm, 590 μm, 600 μm, 610 μm, 620 μm, 630 μm, 640 μm, 650 μm, 660 μm, 670 μm, 680 μm, 690 μm, 700 μm, 710 μm, 720 μm, 730 μm, 740 μm, 750 μm, 760 μm, 770 μm, 780 μm, 790 μm, 800 μm, 810 μm, 820 μm, 830 μm, 840 μm, 850 μm, 860 μm, 870 μm, 880 μm, 890 μm, 900 μm, 910 μm, 920 μm, 930 μm, 940 μm, 950 μm, 960 μm, 970 μm, 980 μm, 990 μm, 1000 μm. Intermediate quantities are also possible.

In the illustrated embodiment, the back layer 14 is manufactured from a GD cardboard. However, it is also possible that it is produced from a GD liner, a grey board, a test liner and/or a paper layer. The back layer 14 is additionally produced coated in the embodiment. However, it can also be produced uncoated. The cover layer 12 is also produced from a GD cardboard in the illustrated embodiment. However, it is also possible that a GD liner or a coated paper layer is used for producing the cover layer 12.

The net- or fabric-like reinforcing material 18 can basically be composed of synthetic and/or natural fiber and/or fabric materials. Excellent results were for example achieved with sinusoidal rovings of plastic. Diagonal roving forms or rovings with double threads also show considerably higher tear strength, which in turn contributes to a high mechanical strength of the layered material 10. Therein, the net- or fabric-like reinforcing material 18 can have an area-related mass of 1-30 g/m², in particular 1-15 g/m². This means that net- or fabric-like reinforcing materials 18 with an area-related mass of 1 g/m², 2 g/m², 3 g/m², 4 g/m², 5 g/m², 6 g/m², 7 g/m², 8 g/m², 9 g/m², 10 g/m², 11 g/m², 12 g/m², 13 g/m², 14 g/m², 15 g/m², 16 g/m², 17 g/m², 18 g/m², 19 g/m², 20 g/m², 21 g/m², 22 g/m², 23 g/m², 24 g/m², 25 g/m², 26 g/m², 27 g/m², 28 g/m², 29 g/m², 30 g/m² can be employed. Intermediate quantities are also possible. However, it is also conceivable that net- or fabric-like reinforcing materials 18 with a higher area-related mass are used.

FIG. 2 shows a schematic representation of a device 40 for producing the layered material 10, as it is represented and described in FIG. 1. One recognizes that the device 40 has a first transport device 20 for transporting a first cardboard or paper web 22 forming the first cardboard or paper layer 12, a second transport device 24 for transporting a second cardboard or paper web 26 forming the second cardboard or paper layer 14, a third transport device 28 for transporting a web 30 of a net- or fabric-like reinforcing material 18, two devices 32, 34 for applying an adhesive and/or starch solution to the first and the second cardboard or paper web 22, 26 as well as a device 36 for combining the first cardboard or paper web 22 with the second cardboard or paper web 26 as well as the web 30 for forming the layered material 10. One recognizes that the web 30 of the net- or fabric-like reinforcing material 18 is guided between the first cardboard or paper web 22 and the second cardboard or paper web 26. The arrows denoted by Tin FIG. 2 indicate the respective transport direction of the paper or cardboard webs and the web 30 of the net- or fabric-like reinforcing material 18.

1. A layered material for use as a packaging material including at least two layers (12, 14) of cardboard and/or paper, which are connected to each other in material-bonded manner,
wherein
at least one intermediate layer (16) of a net- or fabric-like reinforcing material (18) is arranged between the layers (12, 14) of cardboard and/or paper and at least one cardboard layer or paper layer (12, 14) has a proportion of recycled fibers of at least 80% by weight related to the total weight of the cardboard layer or paper layer (12, 14).

2. The layered material according to claim 1,
wherein
the layers (12, 14) of cardboard and/or paper and the intermediate layer (16) are adhered to each other.

3. The layered material according to
claim 1, wherein
the layers (12, 14) of cardboard and/or paper include a first layer (12) of cardboard or paper as a cover layer facing away from a packaging item and a second layer (14) of cardboard or paper as a back layer facing the packaging item.

4. The layered material according to claim 3,
wherein
at least the first and the second layer (12, 14) of cardboard and/or paper have a proportion of recycled fibers of at least 80% by weight related to the total weight of the cardboard layer or paper layer (12, 14).

5. The layered material according to claim 3,
wherein
the first and/or the second layer (12, 14) are formed in hydrophobic and/or moisture repellent manner.

6. The layered material according to
claim 3, wherein
the back layer has an area-related mass of 40-600 g/m² and/or a thickness of 80-1000 μm, in particular a thickness of 80-800 μm.

7. The layered material according to
claim 3, wherein
the cover layer has an area-related mass of 40-600 g/m² and/or a thickness of 80-1000 μm, in particular a thickness of 80-800 μm.

8. The layered material according to
claim 3, wherein
the back layer is produced from GD cardboard, a GD liner, grey board, a test liner and/or a paper layer, wherein the back layer is produced coated and/or uncoated.

9. The layered material according to
claim 3, wherein
the cover layer is produced from GD cardboard or a GD liner or a coated paper layer.

10. The layered material according to
claim 1, wherein
the net- or fabric-like reinforcing material (18) is composed of synthetic and/or natural fiber and/or fabric materials.

11. The layered material according to
claim 1, wherein
the net- or fabric-like reinforcing material (18) has an area-related mass of 1-30 g/m², in particular 1-15 g/m².

12. The layered material according to claim 1, wherein the layered material (10) is configured and arranged as a three-dimensional structure.

13. The layered material according to claim 12,
wherein
the three-dimensional structure is a folding box, a product carrier or a display for presentation of goods.

14. A device for producing a layered material (10) for use as a packaging material including at least two layers (12, 14) of cardboard and/or paper, which are connected to each other in material-bonded manner, comprising:
a first transport device (20) for transporting a first cardboard or paper web (22) forming a first cardboard or paper layer (12);
a second transport device (24) for transporting a second cardboard or paper web (26) forming a second cardboard or paper layer (14);
a third transport device (28) for transporting a web (30) of a net- or fabric-like reinforcing material (18);
at least one device (32, 34) for applying an adhesive and/or starch solution to the first and/or second cardboard or paper web (22, 26); and
a device (36) for combining the first cardboard or paper web (22) with the second cardboard or paper web (26) as well as the web (30) of the net- or fabric-like reinforcing material (18) for forming the layered material (10), wherein the web (30) of the net- or fabric-like reinforcing material (18) is guided between the first cardboard or paper web (22) and the second cardboard or paper web (26).

15. The device according to claim 14,
wherein
the device (40) further includes at least one calender and/or at least one removal device and/or at least one application device for additives and/or at least one cutting device and/or at least one drying device for drying the multilayer layered material.

16. A method for producing a layered material (10) comprising the steps of:
applying an adhesive and/or starch solution to a first and/or second cardboard or paper web (22, 26); and
combining the first cardboard or paper web (22) with the second cardboard or paper web (26) as well as a web (30) of a net- or fabric-like reinforcing material (18) for forming the layered material (10), wherein the web (30) of the net- or fabric-like reinforcing material (18) is guided between the first cardboard or paper web (22) and the second cardboard or paper web (26).

17. The method according to claim 16,
wherein
the first and/or second layers of cardboard or paper have a moisture content of less than or equal to 40% by weight during the combination of the first cardboard or paper web with the second cardboard or paper web as well as the web of the net- or fabric-like reinforcing material for forming the layered material.

18. The method according to claim 16,
wherein
the adhesive and/or starch solution is applied in dry coat, wherein the applied quantity is 1-40 g/m², in particular 10-20 g/m².
